(19) United States
(12) Patent Application Publication
(10) Pub. No.: US 2013/0010036 A1
(43) Pub. Date: Jan. 10, 2013

(54) PRINT HEADS AND PRINT HEAD FLUIDS

(76) Inventors: Stephen A. Conner, Corvallis, OR (US); Matthew Thornberry, Corvallis, OR (US); Vladimir Jakubek, Corvallis, OR (US); Marc Serra Vall, Barcelona (ES); Jacint Humet Pous, Barcelona (ES); Eduardo Amela Conesa, Granyena de Segarra (ES); Jaime Fernández, Barcelona (ES)

(21) Appl. No.: 13/177,499

(22) Filed: Jul. 6, 2011

(51) Int. Cl. B41J 2/175

(52) U.S. Cl. 347/85

(57) ABSTRACT

Print heads and print head fluids are disclosed. An example print head for an inkjet printer system includes a fluid reservoir, and a nozzle fluidically connected to the fluid reservoir. The example print head also includes a fluid having a liquid vehicle component and a tinting dye. The fluid is provided in the fluid reservoir during shipping of the print head to maintain wetting of the print head. The fluid is discharged after installation of the printer head in the inkjet printer system.

### BACKGROUND

Color printers, such as inkjet printers, have become increasingly more commonplace with advances in printing technologies. High-quality color printers are readily commercially available in a wide variety of sizes and prices ranging from portable and desktop printers for use at home or at the office, to large commercial-grade printers. Traditionally, printers were used primarily for printing text documents. Today, however, color printers are available and are routinely used to print complex images, such as digital photographs.

Inkjet printers utilize print heads, often referred to as inkjet cartridges. The inkjet cartridges include nozzles in fluid communication with an ink reservoir, and a means for discharging the ink from the nozzles. The reservoir may be provided integrally with, or separately from the print heads. The reservoir is filled with ink (often with pigment-based ink) for printing operations. Pigment-based inks include high concentrations of insoluable pigment particles, which may be coated with a dispersant to maintain the pigment particles suspended in a solute or other liquid (more generally referred to as a “liquid vehicle”).

However, large pigment particles may settle and/or the liquid vehicle may degrade over time, either of which may impede or entirely block ink flow to the nozzles of the print head during printing operations. These issues are particularly acute when the print head is shipped with pigment-based ink and the print head is stored for some time until being used in the inkjet printer for printing operations. Thus, even new print heads can exhibit poor performance and result in poor image quality.

### BRIEF DESCRIPTION OF THE DRAWINGS

FIG. 1 is a high-level diagram of an example printer system which may be used with the print heads and print head fluids described herein.

FIG. 2 is a high-level diagram of an example print head and print head fluid.

FIG. 3 illustrates an example alignment process using the print head and print head fluids described herein.

FIG. 4 is a flowchart of example operations using the print head and print head fluids described herein.

### DETAILED DESCRIPTION

Print heads and print head fluids are disclosed. An example print head for an inkjet printer system includes a fluid reservoir (either integral or provided separately) and a nozzle fluidically connected to the fluid reservoir. The print head is filled with a fluid having a liquid vehicle component and a tinting dye. The fluid may be provided in the fluid reservoir during shipping of the print head to maintain wetting of the print head. The fluid may be discharged by the inkjet printer system after installation of the print head in the inkjet printer system.

In an example, the fluid is a shipping fluid. When used as a shipping fluid, the tinting dye may substantially match a color of the ink to be used during a later printing operation. Accordingly, a manufacturer may discharge the shipping fluid onto a print medium (e.g. paper) during a test printing operation for testing the inkjet printer prior to shipping, and/or by the end-user prior to or during setup.

In another example, the fluid is a pretreatment fluid. A pretreatment fluid may be ejected by an inkjet printer onto a print medium during a printing operation in advance of the ink deposition. The pretreatment fluid enhances the appearance of color on the print medium. Accordingly, pretreatment fluids are typically provided in separate reservoirs from the pigmented inks, and indeed, may even be provided in an entirely different print head. The actual pretreatment fluid which is used may be transparent, however, when the fluid is used in the pretreatment reservoir, the fluid may be tinted or colorized for some time until the printer is calibrated.

It is noted that the fluids described herein may serve a multiple functions. The fluid may be provided in the print head reservoir and used as a shipping fluid to maintain wetting of the print head during shipping. The fluid may also be provided in the print head reservoir and tinted for testing operations. In addition, the same fluid may be used as a pretreatment fluid for an alignment process to ensure that the pretreatment fluid is ejected onto the paper in alignment with the ink during a printing operation. During the alignment process, the tinting dye in the fluid can be readily detected when deposited on the printing medium (unlike a transparent pretreatment fluid), and thus can be used to align the print heads depositing pretreatment fluid with the print heads depositing ink. The fluid with the tinting dye may be wasted after the alignment process, and replaced with a transparent pretreatment fluid for normal printing operations which utilize a pretreatment fluid.

In an example, the fluid (when used as a shipping fluid and/or as a pretreatment fluid) may have a higher density than a subsequent ink or transparent pretreatment fluid that is to be discharged from the same reservoir during normal printing operations. The higher density fluid provides a density differential which reduces mixing with the subsequent ink or pretreatment fluid and wastes less of the ink or pretreatment fluid during purging.

The shipping and pretreatment fluids, and corresponding systems and methods disclosed herein may be used to enhance print quality and/or increase overall customer satisfaction with printer products. In addition to providing better print quality, the systems and methods may reduce the number of service calls and other maintenance requirements for printer products.

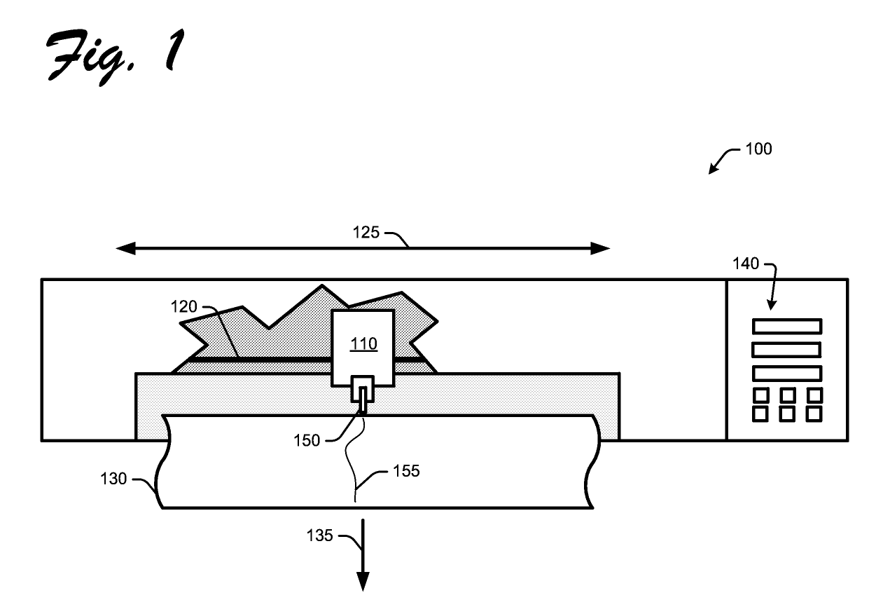

FIG. 1 is a high-level illustration of an example printer system 10 which may be used with the print heads and print head fluids described herein. Example printer system 10 may be implemented as an inkjet printer, or other printer now known or later developed which utilizes print heads and print head fluids. In an example, the printer system 10 may include one or more print heads 12 provided on rail 14. A print medium 16, such as paper or other substrate, can be fed through the printer system 10 using any suitable feed mechanism (not shown).

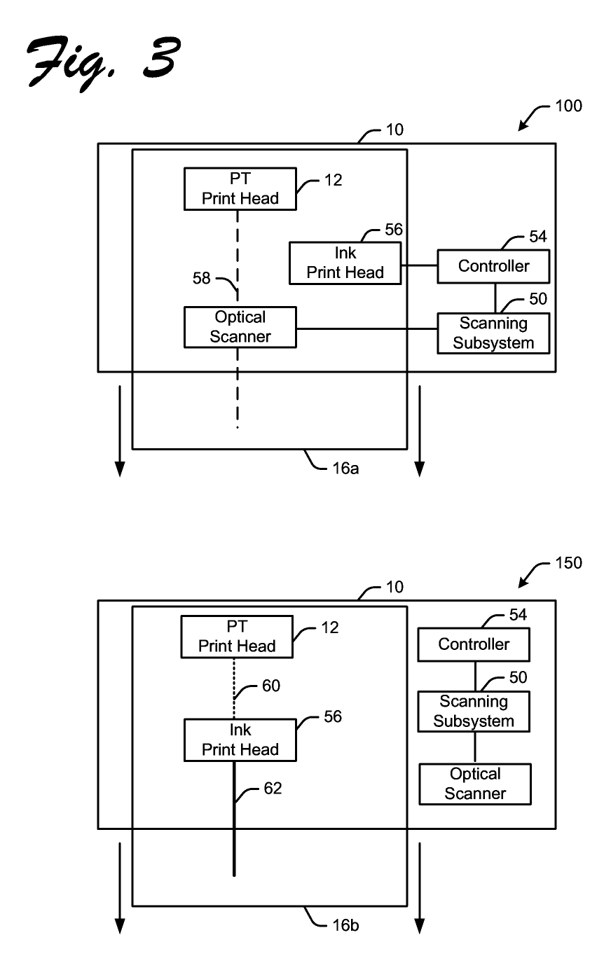

A control mechanism (see, e.g., the controller shown in FIG. 3), such as an electronic controller embodied in circuitry and/or logic, is typically provided to receive print jobs and control the feed mechanism and other printing operations at the printer system 10. The controller may be operatively associated with a control panel 18 on a housing of the printer system 10. The control panel 18 may be used to receive input and provide output to a user.

The print system 10 may also be operatively associated with another device (not shown), such as a computer or other electronic device. The print system 10 may be connected directly to the device, such as by a USB cable, or via a local or wide area network. The printer system 10 may receive print jobs from the external device for output during a printing operation.

During printing operations, the controller causes the print head 12 to move along the rail 14 (e.g., in the directions illustrated by arrow 20) as the feed mechanism moves the print medium 16 adjacent the print head 12 (e.g., in the direction illustrated by arrow 22). The controller may also cause the print head 12 to eject a fluid (e.g., a pigmented ink) onto the print medium 16. The fluid may be drawn from a reservoir associated with the print head 12, and discharged by a nozzle 24 onto the print medium 16, as illustrated by line 26 shown in FIG. 1. The controller may control the flow of ink for transfer onto the print medium 16 during the printing operation.

Print heads and print head fluids are disclosed herein which may be used with the printer system 10 shown in FIG. 1, or other suitable printing systems now known or later developed. An example print head 12 for a printer system 10 includes a reservoir (either internal or external to the print head 12) and a nozzle 24 fluidically connected to the reservoir. The reservoir is filled with a fluid having a liquid vehicle component and a tinting dye, as described in more detail below. The tinting dye may be a single dye, or a combination or mixture of different dyes. For example, a black fluid may include a combination of cyan, magenta, and yellow dyes to give the fluid a black tint.

It is noted that the construction and operation of inkjet printers such as the printer system 10 described above are well understood in the printer arts, and therefore further description is not necessary for a full understanding of the systems and methods described herein. It is also noted that the print heads and print head fluids described herein are not limited to use with the printer system 10 described above with reference to FIG. 1.

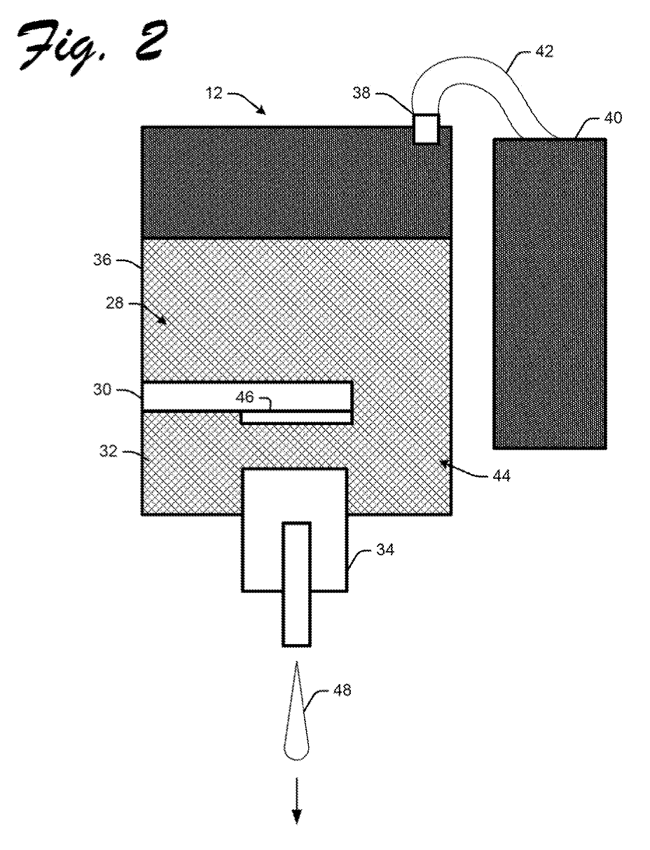

FIG. 2 illustrates an example print head 12 and print head fluid 28. The print head 12 is generally formed by a substrate 30, a firing chamber 32, and one or more nozzles 34. Firing chamber 32 is formed by side walls and substrate 30 and a nozzle plate, where the substrate 30 is considered the bottom of the reservoir 36 holding the print head fluid 28.

Although only a single nozzle is shown in FIG. 2 for purposes of illustration, an example print head 12 may have a nozzle density on the order of 1200 nozzles per inch, and per color, and a total number of nozzles of over 40,000. In addition, four separate fluid reservoirs may be integrated into a single print head 12, for storing up to four different color inks (cyan, magenta, yellow, and black).

A cross-section of a single fluid reservoir 36 is shown in FIG. 1, and is configured to hold the print head fluid. Depending on the particular print head design, a fluid port 38 may facilitate the flow of fluid through communication with an external ink supply 40, delivering ink under pressure via a connection tube 42. If the print head design includes a self-contained supply of ink, the fluid port 103 may facilitate the flow of ink by force of exterior air being drawn into the chamber 36 as the ink exits the nozzle 34.

In either example, the fluid reservoir 36 is fluidically coupled to a substrate 30 via fluid inlet passage 44. The substrate 30 may be attached to the body of the print head 12, and includes an energy-generating element or fluid ejector 46. Fluid ejector 46 is configured to generate a force to eject a drop 48 of fluid held in the firing chamber 32. During operation, fluid ejector 46 generates a discrete number of drops of substantially the same size (or volume) drops.

By way of illustration, fluid ejector 46 may be a thermal resistor which rapidly heats a component resulting in ejection of a drop 48 of the fluid. In another example, fluid ejector 46 may be a piezoelectric element. A piezoelectric element utilizes a voltage pulse to generate a compressive force on the fluid, resulting in ejection of a drop 48 of the fluid. Other fluid ejectors 46 may also be used, such as hydraulic, air assisted, or ultrasonic spray nozzles, to name only a few additional examples. In addition, the drops 48 need not all be uniform in size or volume.

In an example, the print head fluid 28 may be a shipping fluid. In another example, the print head fluid 28 is a pretreatment fluid. The fluid 28 may also serve a dual function. That is, the fluid 28 may be provided in the print head reservoir 36 and used as a shipping fluid to maintain wetting of the print head 12 (e.g., the nozzles 34) during shipping. In addition, the fluid 28 may be used as a pretreatment fluid for an alignment process to ensure that the pretreatment fluid is ejected onto the paper in alignment with the ink during a printing operation.

In any of these examples, the fluid 28 may be provided in the reservoir 36 during shipping of the print head 12 to maintain wetting of the print head 12. The print head fluid 28 may be a benign fluid. That is, the fluid 28 does not degrade over time (or at least not as quickly as pigmented ink), because there are no pigments or other particles to settle out of the fluid 28. The shipping fluid is less chemically aggressive than ink which increases the time based reliability of print heads and ink delivery systems because they are not in contact with ink throughout the shipping channel.

In tests, the fluid 28 extended the life of print heads by an additional 12 to 18 months. Accordingly, the print heads shipped using the fluid 28 described herein have an extended operating life.

The fluid 28 may be discharged after installation of the print head 12 in the printer system. In an example, the fluid 28 may be discharged as part of printer testing operations. The tinting in the fluid 28 enables the test administrator to see the fluid printed on the medium for verifying the test results, just as the test administrator would be able to see pigmented ink. But by not having to use pigmented ink during testing, the print head 12 does not become clogged with dried ink remnants after the testing procedure during shipping and before use by the end-user.

Such use of the fluid 28 has far reaching effects. In previous approaches, each new pigmented ink that was developed for use with a printing system had new, unique failure modes. These failures ranged from etched silicon on the print head, to the pigment settling during shipping. Manufacturers thus had to test each revision of ink to determine if the new ink could survive being in a shipping channel for a typical 18 month time period, without causing damage to the print head or otherwise being degraded prior to use. Variable environmental conditions made these tests difficult to repeat with any measure of reliability.

Because these tests took so long, manufacturers would often skip testing, or conduct only limited testing, before shipping new revisions of pigmented inks. But using the fluid described herein, the manufacturer can reduce transportation and learning cycles because the fluid does not change over time and is independent of ink revisions or printing systems. The same fluid may be used in any number of printing systems, regardless of the pigmented inks which will ultimately be used in the printing system. In all uses, there is no uncertainty that the shipped print heads will arrive in a damaged or unusable state.

In addition, the fluid 28 reduces the requirements on sealing the print head nozzles during shipping. That is, high-precision nozzle tape or caps are not necessary, because the tinted fluids do not damage the print head as the residual from leaking pigmented inks might damage a print head or clog a nozzle in the print head. In addition, different color tinted fluids can mix during shipping, and/or the fluid can deteriorate during shipping, both without affecting the end-user experience. That is, the tinted fluids will be fully discharged from the print heads and replaced with pigmented inks before being used for printing operations.

The fluid 28 also results in a direct cost savings. That is, purging the fluid after shipping the print head 12 is not as expensive as having to purge ink from the print system after installing the print head 12 and before the customer can use the print head 12 in the printer system.

In an example, the fluid 28 may have a higher density than an ink or pretreatment fluid that added to the same reservoir after installing the print head 12 for normal printing operations. If the fluid and ink mix too quickly during an operation to purge the fluid 28 from the print head 12 (e.g., after installing the print head 12 in the inkjet printer), the purging operation will take a long time and waste ink. But the higher density fluid provides a density differential which reduces mixing with the ink or pretreatment fluid subsequently added to the reservoir 36.

The following Table 1 shows actual composition and density data for three example tinted fluids.

TABLE 1

| Component | Cyan | Magenta | Yellow |
|---|---|---|---|
| Dye Stock Solution | Acid | Acid Red 52 | Acid |
| | Blue 9 | | Yellow 17 |
| Target Ink Absorbance | 0.777 | 0.929 | 0.388 |
| Target Dilution | 2000 | 1000 | 1000 |
| % 2-Pyrrolidinone | 5.00 | 5.00 | 5.00 |
| % Glycerol | 35.00 | 35.00 | 35.00 |
| % Surfynol 465 | 1.50 | 1.50 | 1.50 |
| % 2-amino-2-methyl-1,3- | 0.50 | 0.50 | 0.50 |
| propanediol (AMPD) | | | |
| % Bioban CS1246 | 0.18 | 0.18 | 0.18 |
| % Kordek MLX (as is, 10% active) | 0.14 | 0.14 | 0.14 |
| % Proxel GXL (as is 20% active) | 0.15 | 0.15 | 0.15 |
| pH target | 9.2-9.3 | 9.2-9.3 | 9.2-9.3 |
| Density (g/mL) | 1.105 | 1.100 | 1.104 |

As mentioned above, the fluid 28 may be a shipping fluid. When used as a shipping fluid, a tinting dye in the fluid 28 may substantially match a color of the ink to be used during a later printing operation. Accordingly, a manufacturer may discharge the fluid 28 (that is, the shipping fluid) onto a print medium for testing the inkjet printer prior to shipping, and/or by the end-user during setup without having to install actual inks used for printing.

Also as mentioned above, the fluid 28 may be a pretreatment fluid. Pretreatment fluids are ejected by inkjet printers onto a print medium in advance of a printing operation, and serve to enhance the appearance of color on the print medium. Accordingly, the pretreatment fluids are typically provided in separate reservoirs from pigmented inks, and indeed, may even be provided in entirely different print heads. While some pretreatment fluids may be deposited on wide swaths of the print medium regardless of where the ink is to be deposited, more sophisticated printer systems deposit the pretreatment fluid only where the ink is to be deposited. Not only is this approach more cost efficient, reducing the amount of pretreatment fluid that is needed for a printing operation, but this approach can also be faster. Of course, this approach means that the print heads having the pretreatment fluid need to be aligned (or calibrated) with the print heads having the ink.

The alignment procedure can be accomplished using an optical sensor. But pretreatment fluids are generally transparent and cannot be readily detected using optical sensors. Accordingly, pigmented inks had to be installed in place of the actual pretreatment fluids for the alignment procedure, and then the transparent pretreatment fluids can be re-installed for the printing operation. Instead, the fluid 28 can be used as a pretreatment fluid for the alignment process, because the tinted fluid used as a shipping fluid for the print head, can also be readily detected by the optical sensors used for the alignment process.

FIG. 3 illustrates an example alignment process using the print head 12 and print head fluids described herein. Reference 100 shows an alignment operation, and reference 150 shows a subsequent printing operation.

An inkjet printer 10 implementing the alignment process may include a number of subsystems implemented as program code (e.g., firmware or software or other logic instructions) and/or as hardware components. In an example, a scanning subsystem 50 is operatively associated with an optical scanner 52. The optical scanner 52 is configured to scan a printed media 16. The scanning subsystem 50 receives output from the optical scanner 52 and records the output. The output represents the location of printed areas (e.g., lines 58) on the printed media 16a.

During the alignment process (illustrated at reference 100 in FIG. 3), the fluid 28 is first printed on a medium 16a. The tinting dye in the fluid 28 can be detected by the optical scanner 52 and output to the scanning subsystem 50. The output is then used by the controller 54 to align the print head(s) 56 which deposit ink during subsequent printing operations. The fluid 28 may then be wasted and replaced by a transparent pretreatment fluid.

During subsequent printing operations (illustrated at reference 150 in FIG. 3), the print head 12 (now having the transparent pretreatment fluid) deposits the transparent pretreatment fluid on the print media 16b, as illustrated by lines 60. In addition, the print head 56 deposits ink directly over (or substantially over) the areas of the print media 16b having the pretreatment fluid 60 deposited thereon. The ink deposits are illustrated in FIG. 3 being deposited over the pretreatment fluid 60 by lines 62.

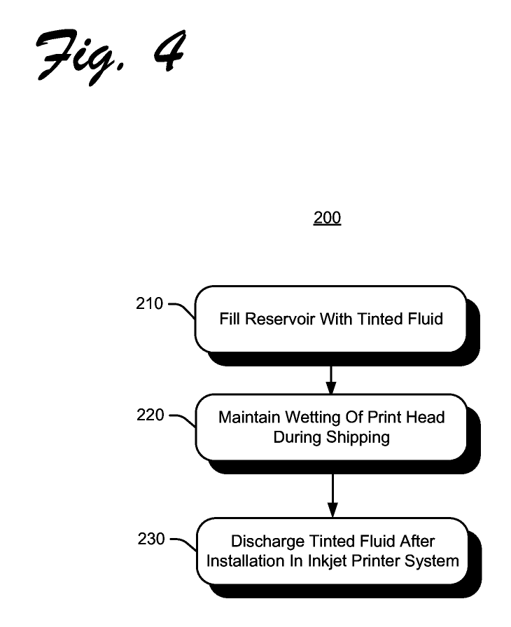

FIG. 4 is a flowchart of example operations 200 using the print head and print head fluids described herein. In operation 210, a reservoir is filled (at least partially) with a tinted fluid. In operation 220, the fluid serves to maintain wetting of the print head during shipping. In operation 230, the tinted fluid is discharged from the reservoir by an inkjet printer after installation of the print head in the inkjet printer system

The examples shown and described herein are provided for purposes of illustration and are not intended to be limiting. Still other examples and variations to the print heads and print head fluids disclosed herein are also contemplated.

1. A print head for an inkjet printer system, comprising:
a fluid reservoir;
a nozzle fluidically connected to the fluid reservoir; and
a fluid having a liquid vehicle component and a tinting dye, the fluid provided in the fluid reservoir during shipping of the print head to maintain wetting of the print head, and the fluid discharged after installation of the print head in the inkjet printer system.

2. The printer head of claim 1, wherein the tinting dye substantially matches an ink pigment to be discharged by the nozzle during operation of the inkjet printer system when the fluid is a shipping fluid.

3. The printer head of claim 1, wherein the fluid is discharged onto paper for print testing.

4. The printer head of claim 1, wherein the fluid is a higher density than an ink to be discharged by the nozzle during operation of the inkjet printer system.

5. The printer head of claim 1, wherein the fluid is a shipping fluid.

6. The printer head of claim 1, wherein the fluid is a colorized pretreatment fluid for ejecting onto a medium in advance of printing an ink on the medium to enhance appearance of color of the printed ink.

7. The printer head of claim 6, wherein the tinting dye in the pretreatment fluid is detected by an optical sensor on the medium during an alignment process, the optical sensor distinguishing colored ink on a white medium.

8. The printer head of claim 7, wherein the pretreatment fluid with the tinting dye is wasted after the alignment process and replaced in the print head with a transparent pretreatment fluid.

9. The printer head of claim 6, wherein the pretreatment fluid is provided in a separate chamber from an ink source.

10. An inkjet printer system comprising:
a print head having a fluid reservoir; and
a tinted shipping fluid provided in the fluid reservoir and discharged after installation of the print head.

11. The inkjet printer system of claim 10, wherein the shipping fluid maintains wetting of the print head prior to use.

12. The inkjet printer system of claim 10, wherein the tinted shipping fluid substantially matches an ink pigment discharged during a subsequent printing operation.

13. The inkjet printer system of claim 10, wherein the tinted shipping fluid is discharged onto a medium for manufacturer testing operations.

14. The inkjet printer system of claim 10, wherein the tinted shipping fluid is a higher density than an ink to be discharged during a printing operation.

15. The inkjet printer system of claim 10, wherein the tinted shipping fluid is wasted before a printing operation.

16. The inkjet printer system of claim 10, wherein the tinted shipping fluid is a pretreatment fluid for ejecting onto a medium in advance of printing an ink on the medium to enhance appearance of color of the printed ink.

17. The inkjet printer system of claim 16, wherein the tinting dye in the pretreatment fluid is detected on the medium during an alignment process, and the pretreatment fluid is wasted after the alignment process and replaced in the print head with a transparent pretreatment fluid.

18. A method comprising:
filling a reservoir with a tinted fluid to maintain wetting of the print head during shipping, wherein the tinted fluid is discharged from the reservoir by an inkjet printer after installation of the print head in the inkjet printer system.

19. The method of claim 18, further comprising:
tinting the fluid to substantially match a pigmented ink discharged during a subsequent printing operation by the inkjet printer system; and
increasing a density of the fluid to be greater than a pigmented ink density for the inkjet printer system, wherein the fluid is a shipping fluid.

20. The method of claim 18, further comprising:
ejecting the tinted fluid from the reservoir onto a medium in advance of printing an ink on the medium;
detecting the tinted fluid on the medium during an alignment process;
wasting remaining tinted fluid from the reservoir after the alignment process; and
automatically replacing the tinted fluid in the reservoir with a transparent pretreatment fluid.
